(19) United States
(12) Patent Application Publication
(10) Pub. No.: US 2017/0032917 A1
(43) Pub. Date: Feb. 2, 2017

(54) ELECTRONIC SWITCH DEVICE WITH CERAMIC MATERIALS

(71) Applicant: Sung-Jen Wu, New Taipei City (TW)

(72) Inventor: Sung-Jen Wu, New Taipei City (TW)

(21) Appl. No.: 14/811,784

(22) Filed: Jul. 28, 2015

(51) Int. Cl. H01H 50/38; H01H 50/44; H01H 50/02

(52) U.S. Cl. CPC H01H 50/38; H01H 50/02; H01H 50/443

(57) ABSTRACT

An electronic switch device with ceramic materials comprises a housing, a detenting assembly, and an isolating composite material. The housing has a first half portion and a second half portion. A receiving chamber is defined by the first half portion and the second half portion. The detenting assembly is received in the receiving chamber and arranged in the second half portion. The isolating composite material is arranged at one side surface of the second half portion corresponding to the receiving chamber. The isolating composite material is isolated the contact between the second half portion and the detenting assembly.

### BACKGROUND OF THE INVENTION

1. Field of the Invention

The present invention relates to an electronic switch device with ceramic materials, and especially relates to an electronic element capable for controlling the circuit ON or OFF. It may prevent the sparkles generated by the current from contacting the non-metal part and further reduce the occurrence of melting and burning the non-metal part to prevent from influencing the operation of the current.

2. Description of Related Art

In general precision instruments, the circuit board is the core which may operate with other electronic elements to make the whole instruments operate smoothly. The electronic elements are the basic part in the electronic circuit. They are individually packaging in general and each of them has two or more leads or metal pads. The electronic elements must connect with one another to form an electronic circuit with a specific function, such as the amplifier, the radio receiver, and the oscillator. The general method of connecting with the electronic elements is melting. The electronic elements may be individually packaged by each (resistor, capacitor, inductor, diode, and etc.), or the group with various complexities, such as integrated circuit (operational amplifier, network resistor, logic gate). Besides, the electronic elements may be classified into terminal and connector (for electrical connection device), power cord (for connecting interface or end terminal), switch (capable for controlling the electronic elements ON or OFF), resistor (electronic elements with resistance), protection device (passive elements mounted on the protection circuit in higher voltage or current), capacitor (the elements may storage the electric charges in electric field for filtering, the capacitor may normally change the alternating voltage but not change the constant direct voltage), electro-magnetic sensing device (the electronic elements with magnetism), network (composite electronic element composed of many or many kinds of passive components), memristor, piezoelectric device and crystal resonator (the passive element with Piezoelectricity), power source (current source), sensor, and etc.

The most of above mentioned electronic elements may be packaged by the resin dispensing, especially for the electronic switch elements to isolate and protect from being influenced by the environment. However, the sparkles are generated while the current is ON and two electrically conductive ends are separated from each other. Besides the sparkles may damage the electronic elements, they may also melt and burn the plastic housing which is formed after packaging the electronic element (such like relay, socket of each electronic element, timer, and etc.). The cause of fire may be caused by the sparkles generated from the electronic elements arranged inside the electronic device. Although the package made by resin dispensing may improve the insulating quality, it is not heat-resisting and the resin dispensing may become brittle and hard to have better insulation. Finally, the sparkles may still damage the plastic housing and the inside components.

In view of the foregoing circumstances, the inventor has invested a lot of time to study the relevant knowledge, compare the pros and cons, research and develop related products. After quite many experiments and tests, the “electronic switch device with ceramic materials” of this invention is eventually launched to improve the foregoing shortcomings, to meet the public use.

### SUMMARY OF THE INVENTION

An object of this invention is providing an electronic switch device with ceramic materials for preventing from sparkling to contact the plastic housing of the electric elements to result in melting, burning, and further fire and protecting the operation of the components arranged inside the electronic elements while the current is ON and two electrically conductive ends are separated from each other compared to the conventional electronic switch elements.

In order to achieve above mentioned effects, an electronic switch device with ceramic materials is provided. The electronic switch device may comprise a housing, having a first half portion and a second half portion, and a receiving chamber is defined by the first half portion and the second half portion; a detenting assembly, received in the receiving chamber and arranged in the second half portion; and an isolating composite material, arranged at one side surface of the second half portion corresponding to the receiving chamber, the isolating composite material is isolated the contact between the second half portion and the detenting assembly.

In some embodiments, the isolating composite material is a ceramic sheet and covered on the side surface of the second half portion corresponding to the receiving chamber.

In some embodiments, the isolating composite material is a ceramic powder and coated on the side surface of the second half portion corresponding to the receiving chamber.

In some embodiments, the isolating composite material is a ceramic powder and coated on an inner side surface and an outer surface of the second half portion.

In some embodiments, the detenting assembly further includes a magnetic coil portion and an electrically conductive metal portion.

In some embodiments, the isolating composite material is further arranged at one side surface of the first half portion corresponding to the receiving chamber.

Furthermore, an electronic switch device with ceramic materials is provided. The electronic switch device may comprise a housing, having a first half portion and a second half portion, and a receiving chamber is defined by the first half portion and the second half portion; a detenting assembly, received in the receiving chamber and arranged in the second half portion; and an isolating composite material, arranged at one side surface of the first half portion corresponding to the receiving chamber, the isolating composite material is isolated the contact between the first half portion and the detenting assembly.

In some embodiments, the isolating composite material is a ceramic sheet and covered on the side of the first half portion corresponding to the receiving chamber.

In some embodiments, the isolating composite material is a ceramic powder and coated on the side surface of the first half portion corresponding to the receiving chamber.

In some embodiments, the isolating composite material is further arranged at one side surface of the second half portion corresponding to the receiving chamber.

In conclusion, the advantage is that the arrangement of the isolating composite material may ensure to prevent the sparkles from damaging the first half portion and the second half portion when the current is ON and two electrically conductive ends are separated from each other, ensure the smooth operation of the detenting assembly, and reduce the risk of disaster.

The various objectives and advantages of the present invention will be more readily understood from the following detailed description when read in conjunction with the appended drawing.

### BRIEF DESCRIPTION OF THE DRAWINGS

FIG. 1 is a perspective view of an electronic switch device with ceramic composite materials of the present invention which is applied to a relay;

FIG. 2 is a partial perspective view of a first embodiment of the electronic switch device of the present invention;

FIG. 3 is an exploded view of FIG. 2;

FIG. 4 is a cross-sectional view of FIG. 2 along line A-A;

FIG. 5 is a partial enlarged view of FIG. 4;

FIG. 6 is an exploded view of one type of the first embodiment of the electronic switch device of the present invention;

FIG. 7 is a partial perspective views of a second embodiment of the electronic switch device of the present invention;

FIG. 8 is a cross-sectional view of FIG. 7 along line B-B;

FIG. 9 is a partial enlarged view of FIG. 8;

FIG. 10 is a partial perspective view of a third embodiment of the electronic switch device of the present invention;

FIG. 11 is an exploded view of FIG. 10;

FIG. 12 is a cross-sectional view of FIG. 10 along line C-C;

FIG. 13 is a perspective view of a fourth embodiment of the electronic switch device of the present invention;

FIG. 14 is a cross-sectional view of FIG. 13 along line D-D; and

FIG. 15 is a cross-sectional view of a first half portion and a second half portion which are made by an isolating ceramic material.

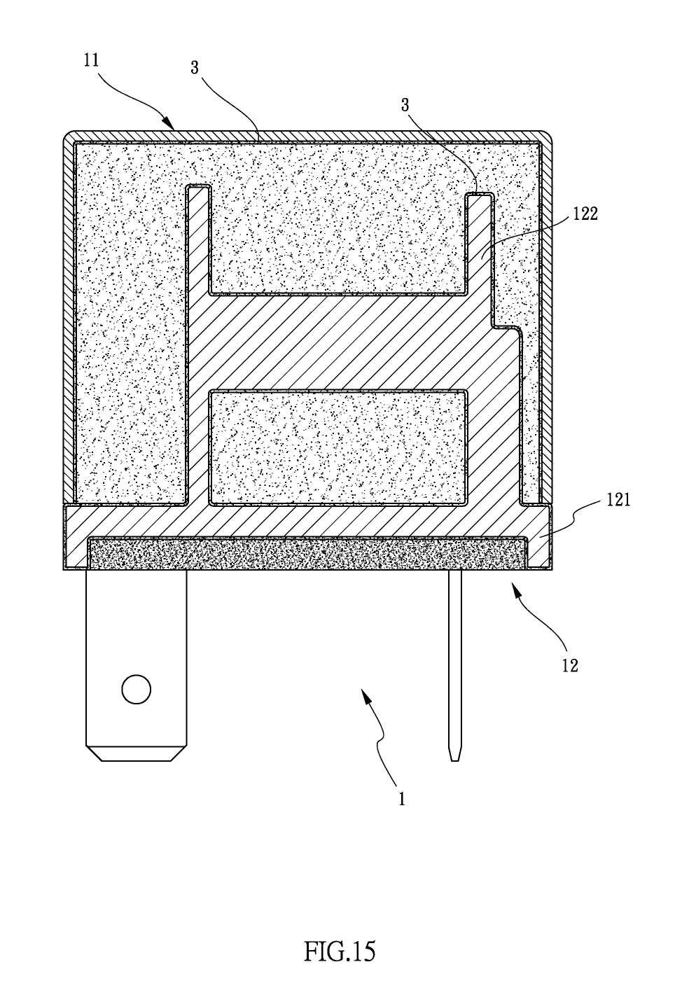

### DETAILED DESCRIPTION OF THE INVENTION

To describe clearly that the present invention achieves the foregoing objective and function, the technical features and desired function are described with reference to a preferred embodiment and accompanying drawings.

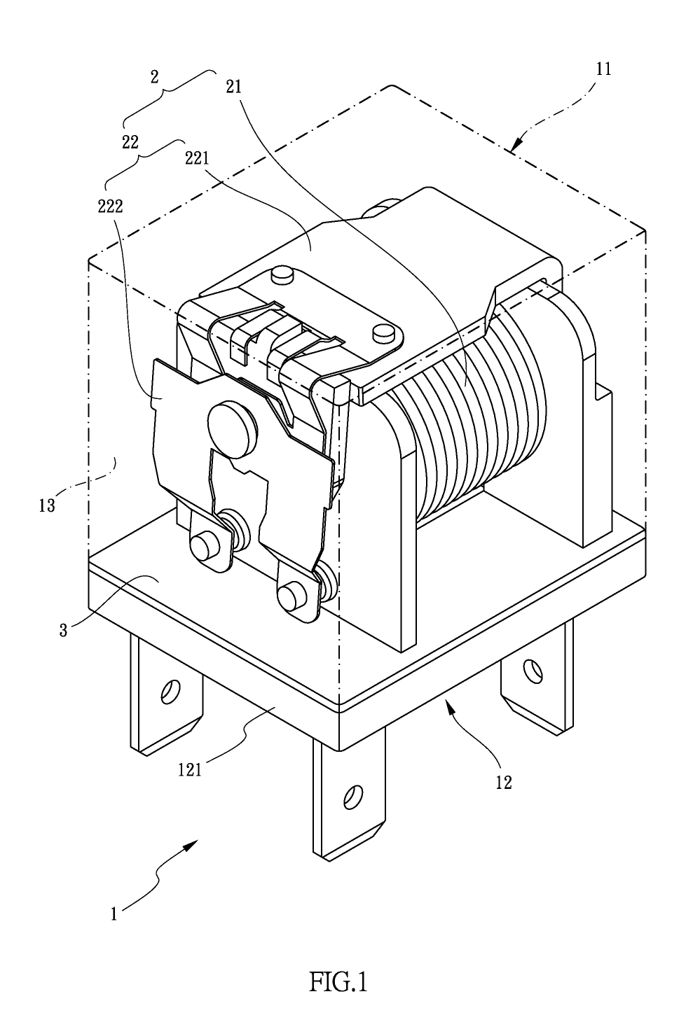

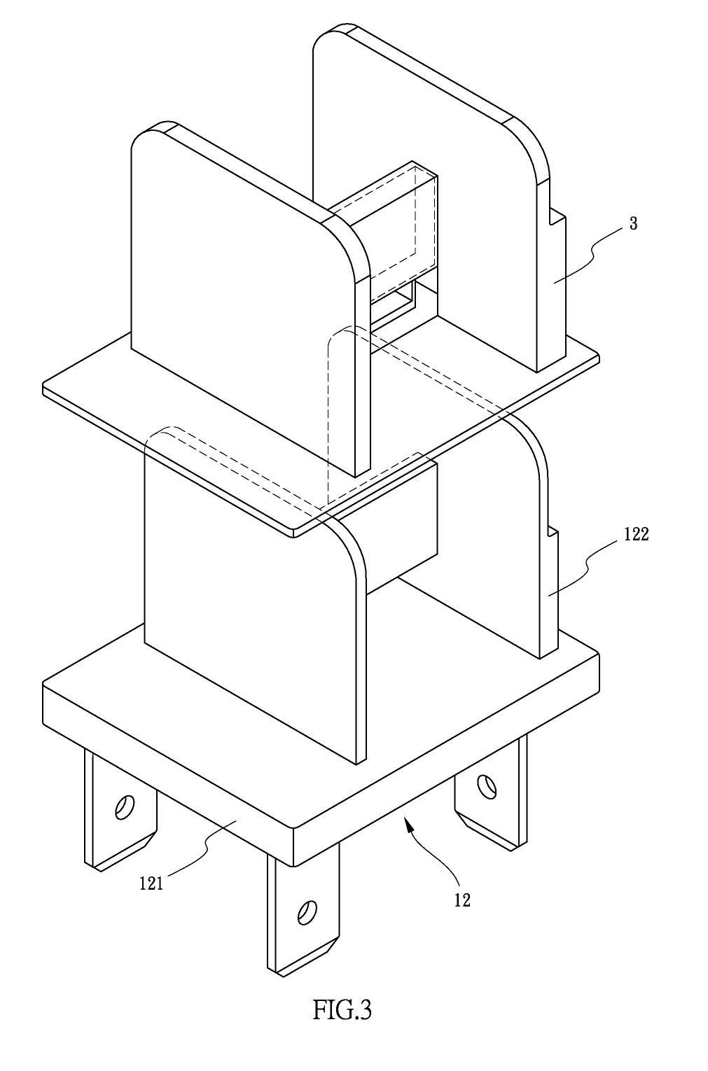

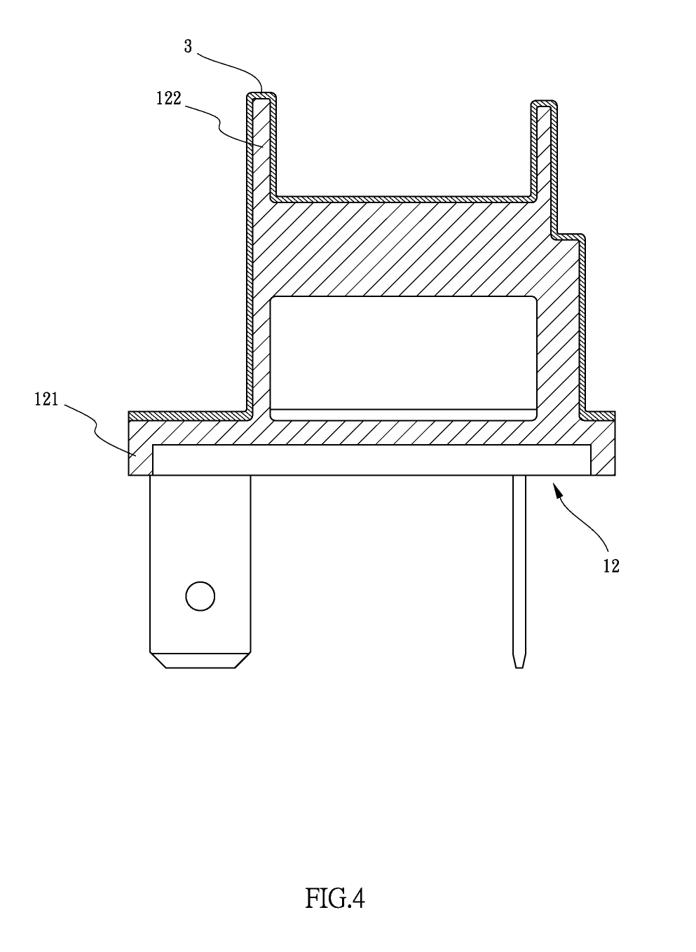

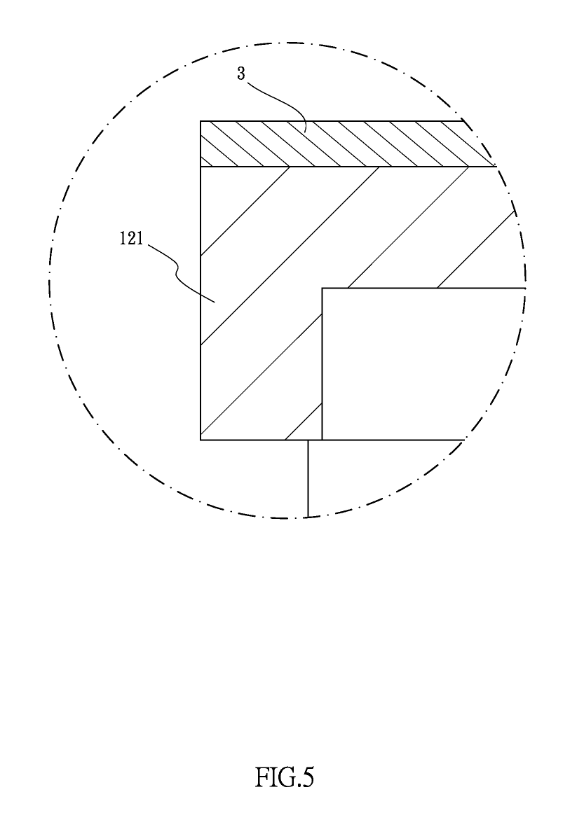

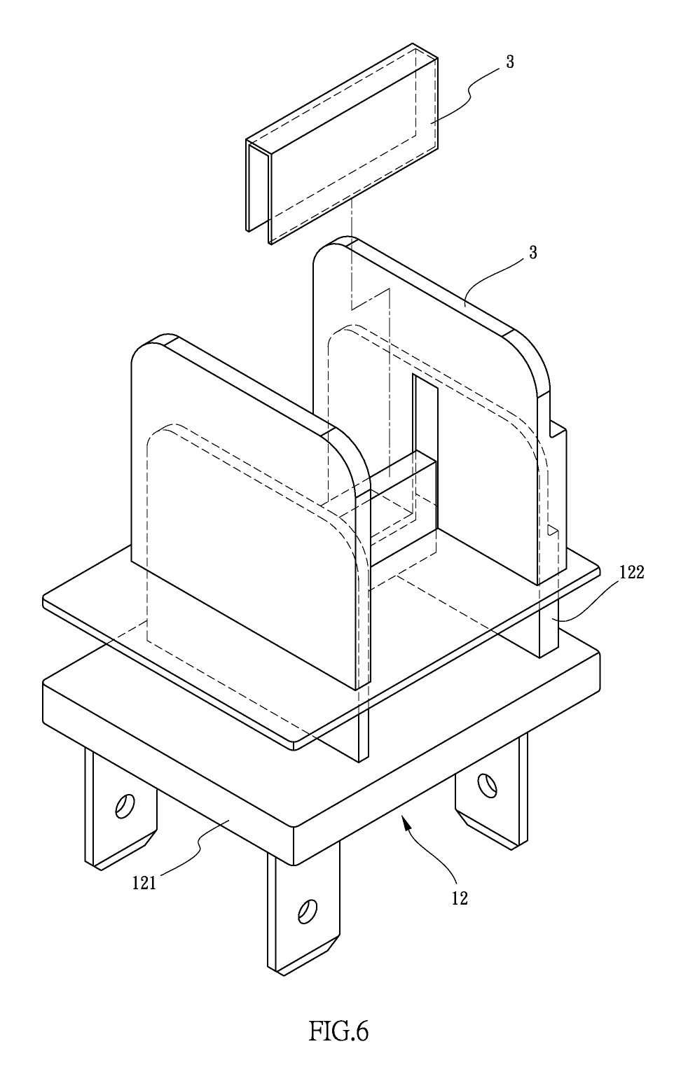

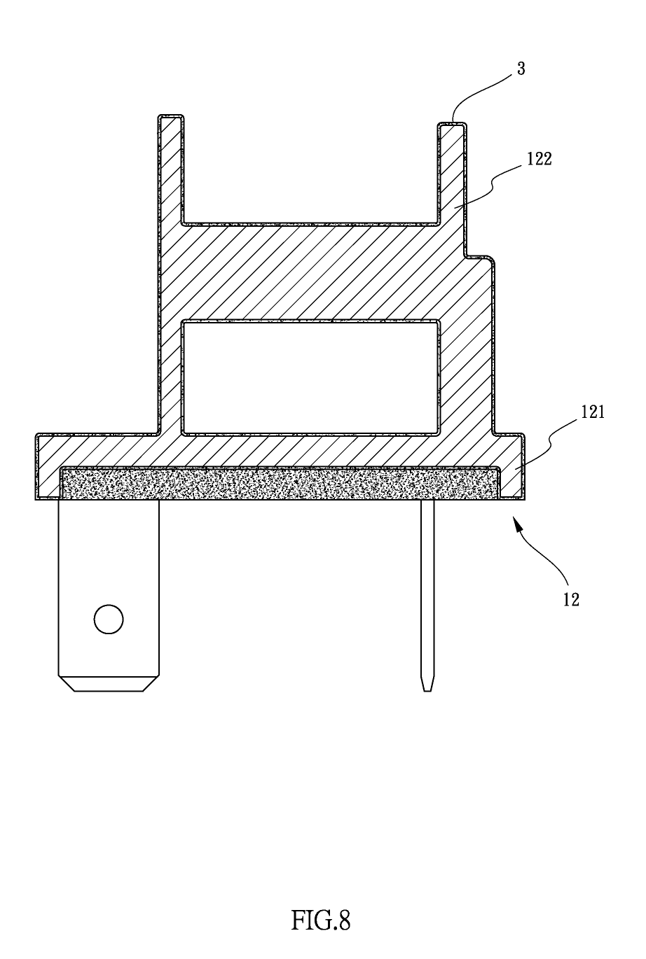

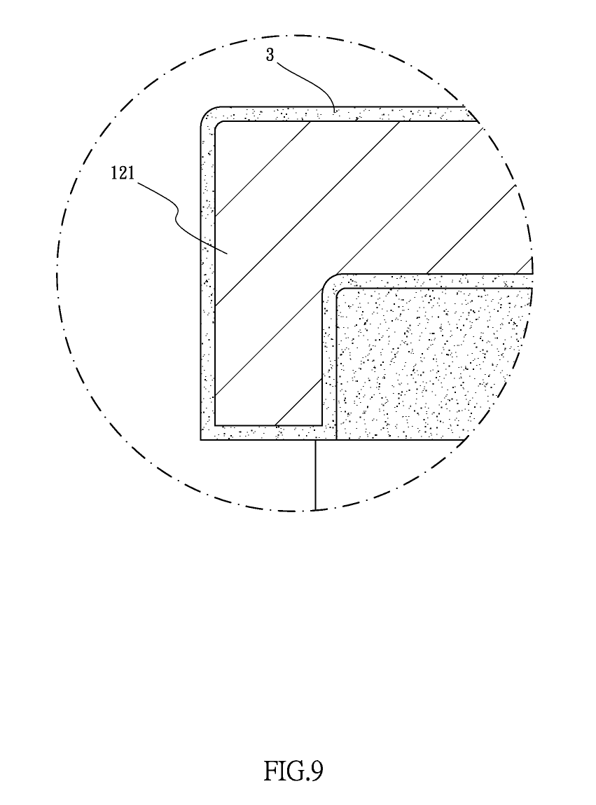

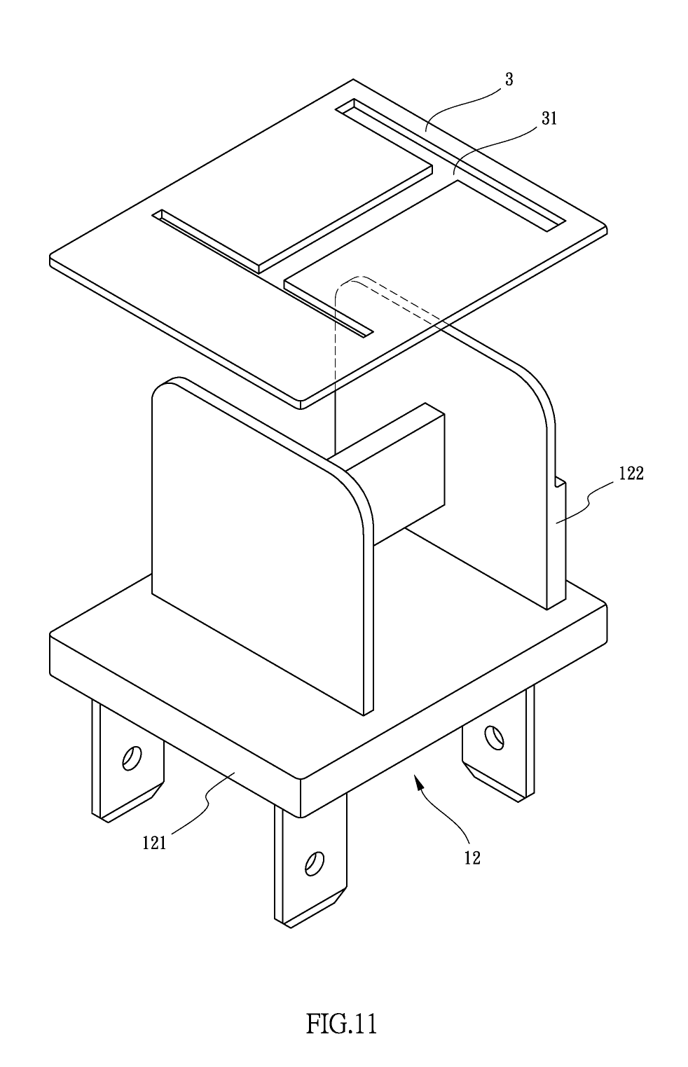

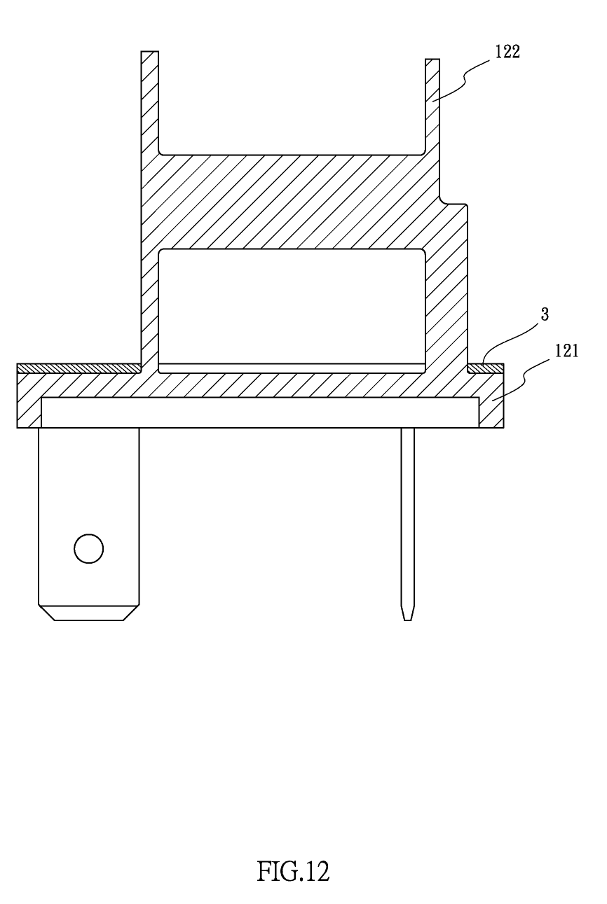

Please reference to FIGS. 1 to 12, an electronic switch device with ceramic composite materials of present invention may comprise a housing 1, a detenting assembly 2, and an isolating composite material 3. The housing 1 may have a first half portion 11 and a second half portion 12. A receiving chamber 13 may be defined by the first half portion 11 and the second half portion 12. The second half portion 12 includes a bottom plate 121 and two vertical plates 122 orthogonal to the bottom plate 121. The detenting assembly 2 may be received in the receiving chamber 13 and arranged in the second half portion 12. And the detenting assembly 2 is used for controlling a circuit board to become an open loop or a closed loop. The isolating composite material 3 may be arranged at one side surface of the second half portion 12 corresponding to the receiving chamber 13. The isolating composite material 3 is used for isolating the contact between the second half portion 12 and the detenting assembly 2. (The above mentioned embodiment is the main skill feature of this invention and corresponds to the claim 1 of this invention to understand the objective and embodiments of this invention in detail. And the skill features of the depending claims are for describing the claim 1 in detail or adding more skill features, but not limited thereto. It should be known that the claim 1 is not necessary to include the skill features of the depending claims.)

A general electronic switch element is mainly used for controlling the circuit to become the open loop or the closed loop, such as a starter. There are many kinds of the electronic switch elements which include a switch for operation by hand, a keypad with many buttons or keys, a relay which is for switching the current and an electro-magnetic element but different from the solid-state relay, a contactor, a thermostat for automatically adjusting temperature, a circuit breaker for automatically opening the overcurrent, a limit switch for mechanically activating, a mercury switch, a centrifugal switch, and a connector. The above mentioned electronic switch elements are frequently used in the precision instruments. However, the common characteristic of the electronic switch elements is having a plastic housing. It is easy to be sparkled while the inside current is generated and then two ends thereof are separated. The sparkle has the instantaneous high temperature which may result in the plastic housing with low melting point being melted and burned and further result in fire. Therefore, the arrangement of the isolating composite material 3 may isolate the detenting assembly 2 which may sparkle and the first and second half portions 11, 12 with low melting point. Thus, the sparkles may not contact the first half portion 11 and the second half portion 12 and the disasters may not happen.

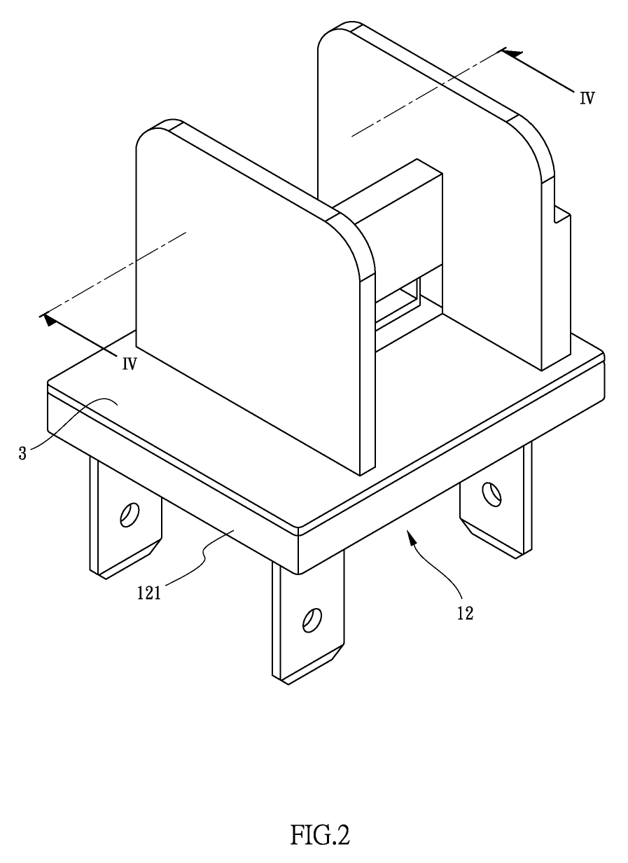

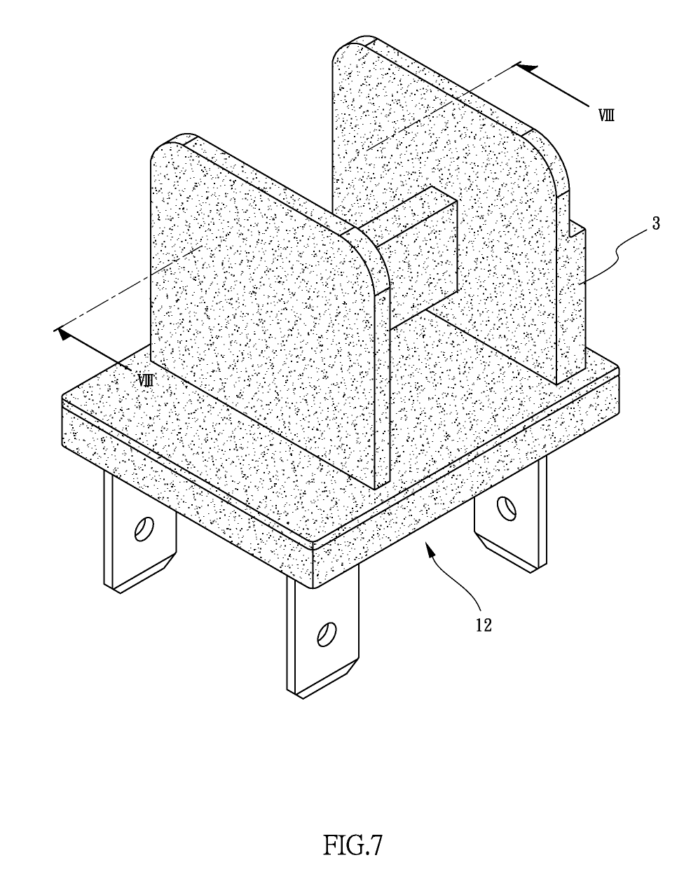

The isolating composite material 3 may be a ceramic sheet. Generally speaking, the ceramic material has the characteristics which include anticorrosion, high temperature resistance, wear resistance, light weight, electrics, magnetics, light, and heat. Therefore, the sparkles may be isolated the ceramic sheet from the second half portion 12 to prevent from damage and dangers. The isolating composite material 3 with the type of the ceramic sheet is arranged at the side surface of the second half portion 12 which is corresponding to the receiving chamber 13 for easy replacement and may ensure to isolate the second half portion 12 from the influence of the sparkles (shown as in FIGS. 2, 3, 6, 10, and 11). Besides, the isolating composite material 3 may be a ceramic powder which may be coated on the outer surface of the second half portion 12 (shown as in FIGS. 7 to 9).

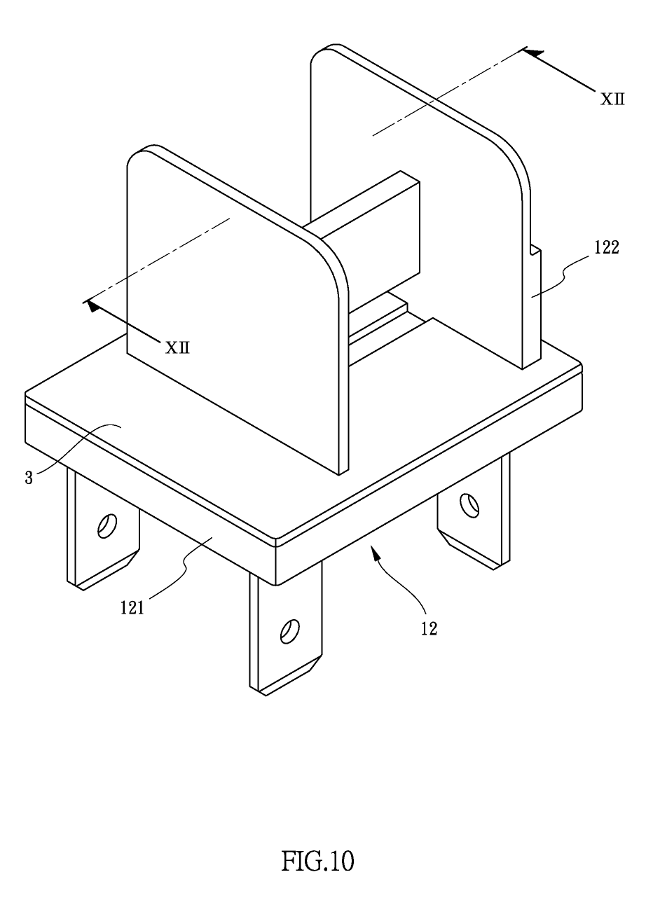

Please refer to FIGS. 2 to 6, the isolating composite material 3 arranged at the second half portion 12 is a form of a cap to cover the bottom plate 12 and a surface of each vertical plate 122 so as to prevent the contact between the detenting assembly 2 and the second half portion 12 and achieve the effect of decreasing the influence of the sparkles (the covering type of the isolating composite material 3 is changeable according to the types of the bottom plate 121 and the vertical plates 122). Please refer to FIGS. 10 to 12, the isolating composite material 3 is not covered on the vertical plates 122. There are two elongated holes 31 which are formed on the isolating composite material 3 with the form of the cap. The vertical plates 122 may be passing through the two elongated holes 31 of the isolating composite material 3 so that the isolating composite material 3 may be adhered to the surface of the bottom plate 121. Please also refer to FIGS. 7 to 9, the isolating composite material 3 is coated on the all surfaces of the bottom plate 121 and the vertical plates 122 so as to ensure to isolate the detenting assembly 2 from the bottom plate 121 and the vertical plates 122. The main objective of above mentioned three embodiments is to isolate the second half portion 12 made by a plastic material from the detenting assembly 2 and prevent from sparkling, burning, and melting. The type of being covered the second half portion 12 by the isolating composite material 3 is not limited thereto. Besides, the part of the second half portion 12 corresponding to the detenting assembly 2 which is easiest to be sparkled may be covered or coated to protect.

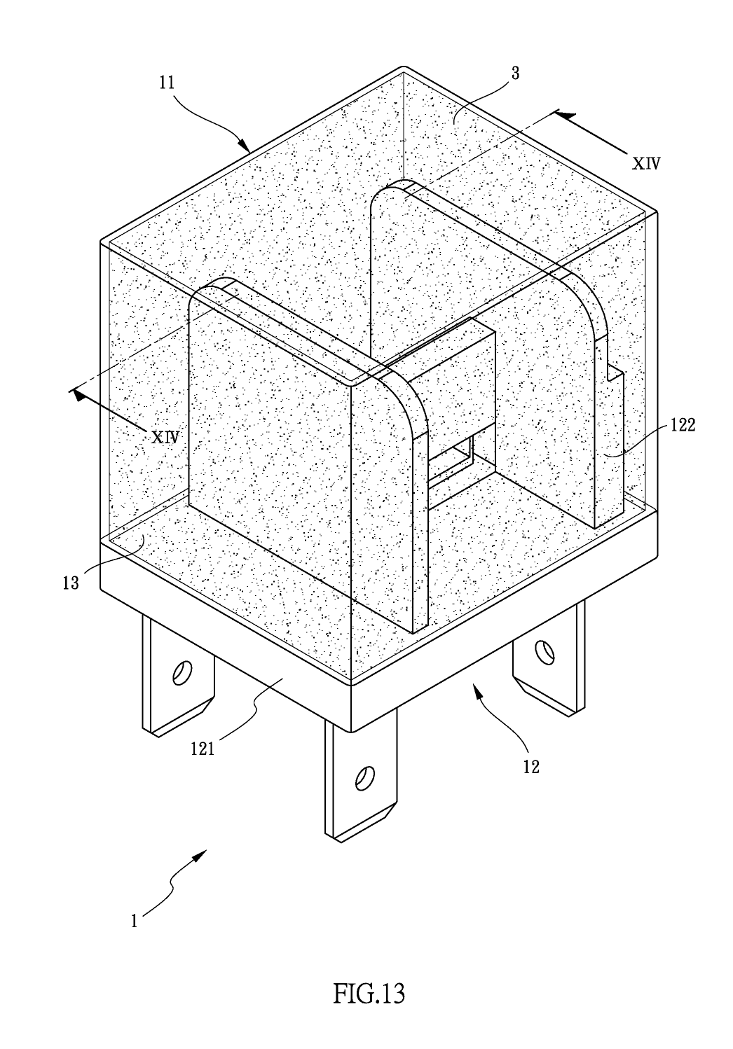

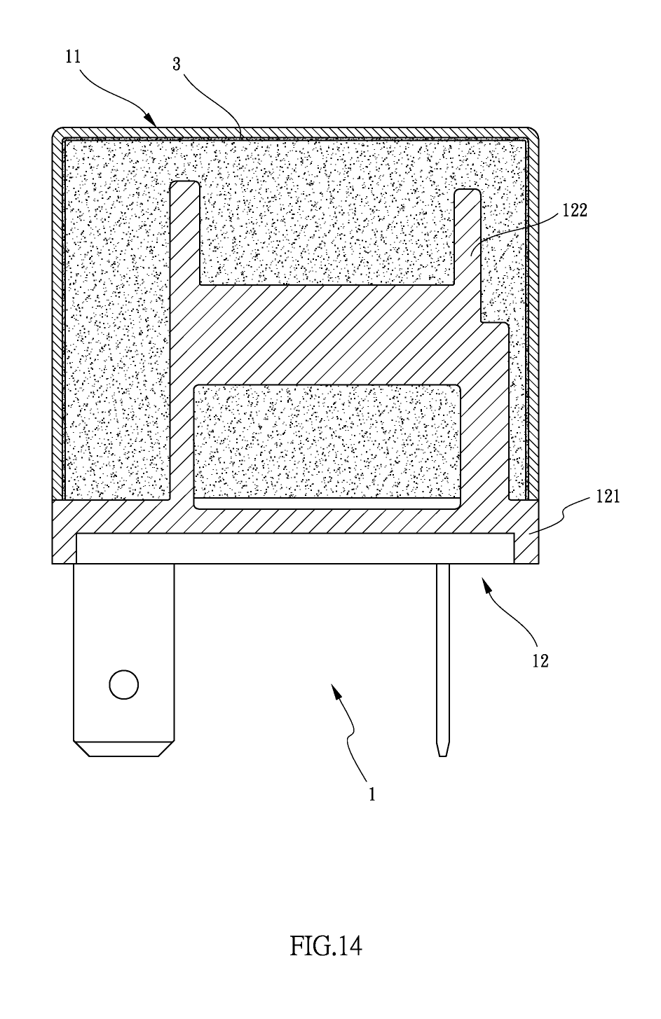

Please refer to FIGS. 13 and 14, the difference between the fourth embodiment and above mentioned three embodiments is that the isolating composite material 3 is arranged at one side surface of the first half portion 11 which is corresponding to the receiving chamber 13. Besides, it may combine the fourth embodiment and the above mentioned three embodiments so that the isolating composite material 3 may be arranged at an inner surface of the first half portion 11 and one side surface of the second half portion 12 corresponding to the receiving chamber 13 or all surfaces of the second half portion 12. Therefore, the protection for the electronic switch elements may be further enhanced and improved.

Furthermore, the detenting assembly 2 may further include a magnetic coil portion 21 and an electrically conductive metal portion 22. The magnetic coil portion 21 is arranged between the two vertical plates 122 of the second half portion 12. The electrically conductive metal portion 22 has a metal flat sheet 221 and a metal lock sheet 222, The metal flat sheet 221 is arranged at a top end of each vertical plate 122, and the metal lock sheet 222 is arranged at outside of one of the two vertical plates 122. One end of the metal lock sheet 222 is assembled with the metal flat sheet 221 and the other end thereof is connected to the outside of the vertical plate 122 (shown as in FIG. 1). The relay illustrated by FIG. 1 shows one of the preferable embodiments. The example of the arrangement of the magnetic coil portion 21 and the electrically conductive metal portion 22 is the inner elements of a specific known relay, but not limited to whole type of relays. The isolating composite material 3 may be also used to other electronic switch elements which may generates sparkles to result in burning, but not only limited to the relays.

The arrangement of the isolating composite material 3 which is cooperated with the characteristic of ceramics is able to isolate the sparkles from the first half portion 11 and the second half portion 12. Thus, the risk of the disasters may be reduced. And compared to the conventional electronic elements, the detenting assembly 2 arranged in the electronic switch elements and the use of the whole electronic switch elements may be protected and have better safety and usefulness.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

What is claimed is:

1. An electronic switch device with ceramic composite materials, comprising:
a housing, having a first half portion and a second half portion, and a receiving chamber is defined by the first half portion and the second half portion;
a detenting assembly, received in the receiving chamber and arranged in the second half portion; and
an isolating composite material, arranged at one side surface of the second half portion corresponding to the receiving chamber, the isolating composite material is isolated the contact between the second half portion and the detenting assembly.

2. The electronic switch device as claimed in claim 1, wherein the isolating composite material is a ceramic sheet and covered on the side surface of the second half portion corresponding to the receiving chamber.

3. The electronic switch device as claimed in claim 1, wherein the isolating composite material is a ceramic powder and coated on the side surface of the second half portion corresponding to the receiving chamber.

4. The electronic switch device as claimed in claim 1, wherein the isolating composite material is a ceramic powder and coated on an inner side surface and an outer surface of the second half portion.

5. The electronic switch device as claimed in claim 1, wherein the detenting assembly further includes a magnetic coil portion and an electrically conductive metal portion.

6. The electronic switch device as claimed in claim 1, wherein the isolating composite material is further arranged at one side surface of the first half portion corresponding to the receiving chamber.

7. An electronic switch device with ceramic composite materials, comprising:
a housing, having a first half portion and a second half portion, and a receiving chamber is defined by the first half portion and the second half portion;
a detenting assembly, received in the receiving chamber and arranged in the second half portion; and
an isolating composite material, arranged at one side surface of the first half portion corresponding to the receiving chamber, the isolating composite material is isolated the contact between the first half portion and the detenting assembly.

8. The electronic switch device as claimed in claim 7, wherein the isolating composite material is a ceramic sheet and covered on the side of the first half portion corresponding to the receiving chamber.

9. The electronic switch device as claimed in claim 7, wherein the isolating composite material is a ceramic powder and coated on the side surface of the first half portion corresponding to the receiving chamber.

10. The electronic switch device as claimed in claim 7, wherein the isolating composite material is further arranged at one side surface of the second half portion corresponding to the receiving chamber.
